(19) United States
(12) Patent Application Publication
(10) Pub. No.: US 2010/0172712 A1
(43) Pub. Date: Jul. 8, 2010

(54) ULTRASOUND ANCHOR AND SETTING METHOD

(76) Inventor: Willi Haug, Freudenstadt-Musbach (DE)

Correspondence Address: MICHAEL J. STRIKER, 103 EAST NECK ROAD, HUNTINGTON, NY, 11743, US

(21) Appl. No.: 12/377,652

(22) PCT Filed: Sep. 27, 2007
(86) PCT No.: PCT/EP07/08418

§ 371 Date: Feb. 16, 2009

(30) Foreign Application Priority Data
Oct. 6, 2006 (DE) 10 2006 047 283.7

(51) Int. Cl. F16B 13/04

(52) U.S. Cl. 411/18

(57) ABSTRACT

The invention relates to a bolt-like ultrasound anchor (1) which at the forward end changes by means of an annular step (3) by way of a desired breaking point (6) integrally into a truncated-cone-shaped expander body (4) and which is provided with slots (5) arranged windmill-like on generating lines of the expander body (4). Together with the annular step (3), the slots (5) form the desired breaking point (6). As a result of the action of ultrasound, the expander body (4) is separated from the ultrasound anchor (1) at the desired breaking point (6) and the ultrasound anchor (1) is pushed onto the expander body (4) and in so doing expanded. In addition, as a result of the action of ultrasound, welding of the ultrasound anchor (1) to the expander body (4) and sintering in a drilled hole take place.

The invention relates to an ultrasound anchor having the features of the preamble of claim 1 and to a setting method having the features of the preamble of claim 8. An ultrasound anchor is to be understood as being an anchor which is set by being subjected to vibrations in the ultrasonic range.

The problem of the invention is to propose an ultrasound anchor suitable for ultrasonic anchoring and a setting method suitable therefore.

That problem is solved according to the invention by the features of claims 1 and 8.

The ultrasound anchor according to the invention is bolt-like and has at the forward end an expander body which widens in the direction of the forward end. The forward end refers to that end of the ultrasound anchor or its expander body which is to the front when the ultrasound anchor is introduced into a blind hole in an anchoring substrate. At the rear end, the ultrasound anchor is mounted for anchoring in an ultrasonic drilling machine, an ultrasonic drilling machine being understood as being a machine which subjects the ultrasound anchor to ultrasonic vibrations, especially to longitudinal vibrations, irrespective of whether a drilling operation is actually taking place. The expander body can be, for example, wedge-shaped, truncated-cone-shaped or truncated-pyramid-shaped. It is integral with the ultrasound anchor by way of a desired breaking point. For expansibility, the ultrasound anchor has at least one slot which, starting from the rear end of the expander body, runs a short way into the ultrasound anchor in the longitudinal direction. The at least one slot therefore begins at the transition from the ultrasound anchor to the expander body and runs from there a short way in the direction of the rear end of the ultrasound anchor. The desired breaking point cannot be located absolutely exactly. It is formed by a cross-sectional weakening, for example by a constriction at the transition from the main body of the ultrasound anchor to the expander body and/or by the at least one slot. Additional notches, slots, constrictions, holes or the like for forming the desired breaking point are also possible.

Once the ultrasound anchor has been introduced into a blind hole in an anchoring substrate and its expander body is seated on the base of the blind hole, as a result of the ultrasound anchor's being subjected to ultrasound its expander body becomes separated from the remainder of the ultrasound anchor and the ultrasound anchor is pushed with its forward region having the at least one slot onto the expander body which is supported at the base of the blind hole. The rear, tapered end of the expander body passes into the at least one slot in the ultrasound anchor and expands the ultrasound anchor. As a result of the action of ultrasound and as a result of the expansion, the ultrasound anchor penetrates into the anchoring substrate and is anchored in the anchoring substrate by interlocking connection and by force-based connection. Preferably, the expander body separated from the remainder of the ultrasound anchor becomes welded to the ultrasound anchor in the at least one slot, so that the expansion is irreversible. In addition to or instead of the welding of the expander body to the ultrasound anchor, the action of the ultrasound can bring about sintering of the ultrasound anchor with the anchoring substrate, with the result that, in addition, anchoring by bonded connection is effected. Failure of the anchoring is possible only as a result of the ultrasound anchor's tearing or breaking out of the anchoring substrate. As a result of the bonded connection of the ultrasound anchor sintered in the anchoring substrate, when the ultrasound anchor is subjected to a load an anchoring force is introduced into the anchoring substrate uniformly over a large area, which counteracts breaking out of the anchoring substrate.

Further advantages of the invention are that the ultrasound anchor, which consists of a single piece, is simple and economical to produce.

To form the expander body and the desired breaking point, in accordance with one construction of the invention the ultrasound anchor changes stepwise into the expander body.

Preferably, the at least one slot is planar; it can thus be made by sawing, for example.

In accordance with one construction of the invention, the at least one slot runs in extension of an expander surface of the expander body. In the case of a truncated-cone-shaped or truncated-pyramid-shaped expander body, the slot runs on a generating line of the expander body. The slot therefore does not run in the longitudinal direction of the expander body but at a (half) pyramid angle or cone angle of the expander body with respect to the ultrasound anchor. The at least one slot thus forms an inwardly directed sloping face with which the ultrasound anchor slides on the expander body during expansion. The position and alignment of the at least one slot has the effect that the expander body, after separation at the desired breaking point, penetrates into the at least one slot and expands the ultrasound anchor in the forward region thereof.

Particularly when the ultrasound anchor has a plurality of slots, in accordance with one construction of the invention the slots do not pass transversely through the ultrasound anchor, so that the expander body is joined to the ultrasound anchor. In accordance with one construction of the invention, a plurality of slots are arranged staggered relative to one another in the peripheral direction, that is to say, for example, on the lateral surfaces of a notional cone which continues the truncated-cone-shaped or truncated-pyramid-shaped expander body, it being possible for the slots to be extended beyond the tip of the notional pyramid.

The method of the invention in accordance with claims 8 and 9 has been explained above in connection with the explanation of claim 1.

The invention is described in greater detail below with reference to an exemplary embodiment shown in the drawing.

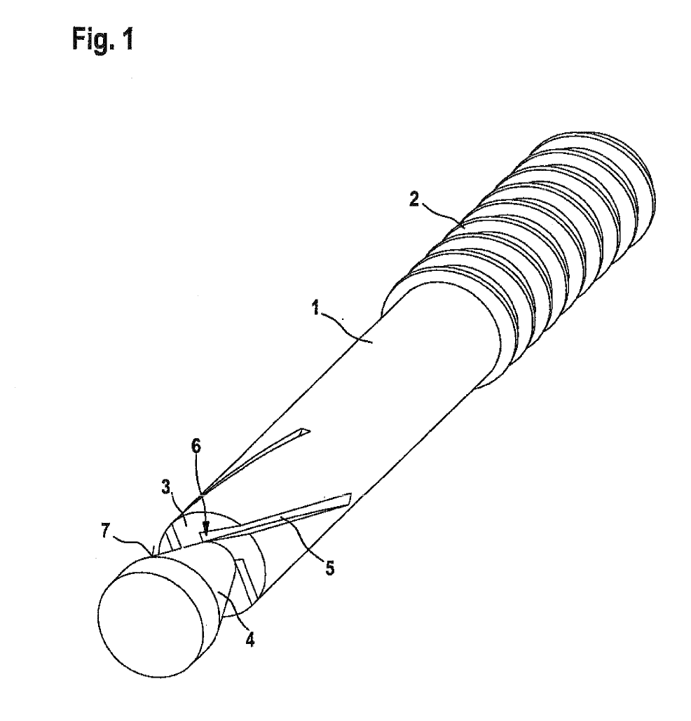

FIG. 1 shows an ultrasound anchor according to the invention in a perspective view obliquely from the front;

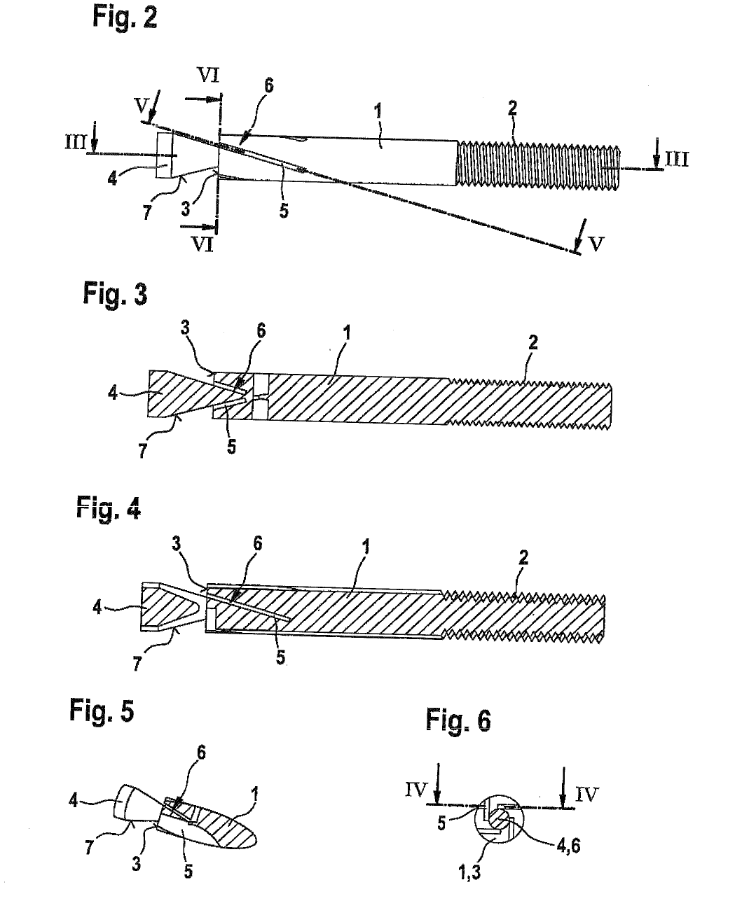

FIG. 2 is a side view of the ultrasound anchor from FIG. 1;

FIG. 3 is an axial section through the ultrasound anchor in accordance with line in FIG. 2;

FIG. 4 is a longitudinal section through the ultrasound anchor from FIG. 1 in accordance with line IV-IV in FIG. 6;

FIG. 5 is an oblique section through the ultrasound anchor from FIG. 1 in

FIG. 6 is a transverse section through the ultrasound anchor from FIG. 1 along line VI-VI in FIG. 2.

The ultrasound anchor 1 according to the invention shown in the drawing has the shape of a cylindrical bolt. The rear end of the ultrasound anchor 1 has a thread for mounting in an ultrasonic drilling machine (not shown). Close to the forward end, the ultrasound anchor 1 changes by means of an annular step 3 into a truncated cone which widens towards the forward end of the ultrasound anchor 1 to the original bolt diameter. The truncated cone forms an expander body 4 integral with the ultrasound anchor 1. Starting from the annular step 3, that is to say from the rear end of the truncated-cone-shaped expander body 4, the cylindrical ultrasound anchor 1 has four slots 5 which are arranged over the periphery like the sails of a windmill and extend a short way into the ultrasound anchor 1 in the longitudinal direction or at an oblique angle with respect to the longitudinal direction. The slots 5 are planar and they are arranged in tangential planes with respect to the truncated-cone-shaped expander body 4. That means that the slots 5 run on side faces of a notional square-based pyramid in extension of the truncated-cone-shaped expander body 4, the slots 5 extending beyond the tip of the notional pyramid.

As can be seen particularly in FIG. 5, the slots 5 do not pass transversely through the ultrasound anchor 1 but reach only as far as its longitudinal centre and end in a curve. As a result, the slots 5 do not intersect one another.

As a result of the stepped reduction in cross-section of the ultrasound anchor 1 at the transition from the cylindrical portion to the truncated-cone-shaped expander body 4 and as a result of the slots 5, the cross-section of the ultrasound anchor 1 at the rear end of the expander body 4 is weakened, and a desired breaking point 6 is formed in the region of the slots 5 and the annular step 3 at the rear end of the expander body 4. The lateral surface of the truncated-cone-shaped expander body 4 forms the expander surface 7 of the ultrasound anchor 1 according to the invention.

The ultrasound anchor 1 according to the invention is intended and suitable for anchoring in solid building materials such as concrete, lime sand brick or solid brick. For anchoring, a blind hole is drilled in the anchoring substrate (not shown) and the ultrasound anchor 1 is mounted by its thread 2 in an ultrasonic drilling machine (not shown) or the like. The ultrasound anchor 1, which is mounted in the ultrasonic drilling machine, is introduced, with the expander body 4 first, into the blind hole in the anchoring substrate until the expander body 4 is seated on the base of the blind hole.

The ultrasound anchor 1 is subjected to ultrasonic longitudinal waves. As a result, the expander body 4 becomes separated from the remainder of the ultrasound anchor 1 at the desired breaking point 6 and the ultrasound anchor 1 is pushed onto the expander body 4. By means of the slots 5 there are formed internal sloping faces with which the ultrasound anchor 1 slides on the lateral surface of the expander body 4 forming the expander surface 7. By being pushed onto the expander body 4, the forward region of the ultrasound anchor 1 having the slots 5 is expanded. Under the action of ultrasound, the expanded regions are driven chisel-like into the wall of the blind hole. The ultrasound anchor 1 is anchored in the blind hole by force-based connection as a result of the expansion and by interlocking connection as a result of being driven into the wall of the blind hole. Under the action of ultrasound, the expanded forward region of the ultrasound anchor 1 having the slots 5 becomes welded to the expander body 4, so that the expansion is irreversible. In addition, the expanded regions driven into the wall of the blind hole become sintered with the anchoring substrate, with the result that, in addition, a bonded connection of the ultrasound anchor 1 to the anchoring substrate is formed.

1. Bolt-like ultrasound anchor, characterized in that the ultrasound anchor (1) has at its forward end an expander body (4) which widens in the direction towards the forward end of the ultrasound anchor (1), which expander body is integral with the ultrasound anchor (1) by way of a desired breaking point (6), and the ultrasound anchor (1) has at least one slot (5) which, from the rear end of the expander body (4), runs a short way into the ultrasound anchor (1) in the longitudinal direction.

2. Ultrasound anchor according to claim 1, characterized in that the expander body (4) is wedge-shaped, truncated-cone-shaped or truncated-pyramid-shaped.

3. Ultrasound anchor according to claim 1, characterized in that the ultrasound anchor (1) changes stepwise into the expander body (4).

4. Ultrasound anchor according to claim 1, characterized in that the at least one slot (5) is planar.

5. Ultrasound anchor according to claim 1, characterized in that the at least one slot (5) runs in extension of an expander surface (7) of the expander body (4).

6. Ultrasound anchor according to claim 1, characterized in that the at least one slot (5) does not pass transversely through the ultrasound anchor (1).

7. Ultrasound anchor according to claim 1, characterized in that the ultrasound anchor (1) has slots (5) which are staggered relative to one another in the peripheral direction of the ultrasound anchor (1).

8. Method of setting an ultrasound anchor, characterized in that the ultrasound anchor (1) has at its forward end an expander body (4) which widens the direction towards the forward end of the ultrasound anchor (1), which expander body is integral with the ultrasound anchor (1) by way of a desired breaking point (6), and the ultrasound anchor (1) has at least one slot (5) which, from the rear end of the expander body (4), runs a short way into the ultrasound anchor (1) in the longitudinal direction, the ultrasound anchor (1) is introduced into a blind hole so that its expander body (4) is seated on the base of the blind hole, and the ultrasound anchor (1) is subjected to ultrasonic vibrations so that the expander body (4) becomes separated from the remainder of the ultrasound anchor (1) at the desired breaking point (6) and the remainder of the ultrasound anchor (1) is pushed with its at least one slot (5) onto the widening expander body (4) and in so doing is expanded by the expander body (4).

9. Method according to claim 8, characterized in that the expander body (4) separated from the remainder of the ultrasound anchor (1) becomes welded to the ultrasound anchor (1) in the at least one slot (5) and/or becomes sintered with the wall of a hole in the expanded region.
